(19) United States
(12) Patent Application Publication
(10) Pub. No.: US 2008/0299298 A1
(43) Pub. Date: Dec. 4, 2008

(54) Methods of Manufacturing Carbon Nanotube (Cnt) Paste and Emitter with High Reliability

(75) Inventors: Dae Jun Kim, Daejeon (KR); Yoon Ho Song, Daejeon (KR); Jin Woo Jeong, Daegu (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, DAEJEON (KR)

(21) Appl. No.: 12/094,480

(22) PCT Filed: Dec. 1, 2006
(86) PCT No.: PCT/KR2006/005149

§ 371 Date: May 21, 2008

(30) Foreign Application Priority Data
Dec. 6, 2005 (KR) 10-2005-0118182
Sep. 5, 2006 (KR) 10-2006-6084912

(51) Int. Cl. B05D 5/12; H01B 1/24

(52) U.S. Cl. 427/77; 252/503; 977/788

(57) ABSTRACT

Provided are methods of manufacturing carbon nanotube (CNT) paste, to which a nano-sized particle is added, and a CNT emitter with high reliability for a field emission display (FED). The method includes the steps of: (i) dispersing CNT powder in a solvent; (ii) adding an organic binder to the solution in which the CNT powder is dispersed; and (iii) performing a milling process to adjust viscosity of the dispersion solution to which the organic binder is added, wherein a nano-sized metal particle is added in step (i) or (iii). Accordingly, the nano-sized metal particle is added as a metal filler of the CNT paste, and thus a metal may be melted at a low temperature at which CNTs do not deteriorate. Thus, adhesion between the CNT paste and a cathode may be improved, and resistance between the cathode and the CNT or between CNTs may be reduced. Further, the CNT paste manufactured by the above method is employed in manufacturing the CNT emitter to thereby obtain uniform emission of electrons from the CNT emitter and increase electron emission sites, and thus the reliability of the CNT emitter may be further improved.

### TECHNICAL FIELD

The present invention relates to methods of manufacturing carbon nanotube (CNT) paste and a CNT emitter, and more particularly, to methods of manufacturing CNT paste which has a nano-sized metal particle as a metal filler, and a CNT emitter with high reliability.

### BACKGROUND ART

With recent developments in display technology, flat panel displays are often being used instead of conventional cathode ray tubes (CRTs). Liquid crystal displays (LCDs), plasma display panels (PDPs), and field emission displays (FEDs) are exemplary flat panel displays.

Among the flat panel display devices, especially FEDs follow similar physical principles to CRTs, except that electron emitters of CRTs are formed of a cold cathode material. In FEDs, an electric field is applied to a very fine field emitter (a cathode), and thereby an electron emitted from the field emitter into vacuum collides with a fluorescent material (that is, a fluorescent material is excited) to display an image. Accordingly, FEDs can be manufactured lightweight and thin still with an excellent display characteristic. As described above, FEDs are ideal in all aspects of the display device, so that they are attracting attention as the next generation display devices with the most potential.

Carbon nanotubes (CNTs) have recently been in the limelight as electron emitters of such FEDs. The CNTs provide the most excellent performance as emitters using a field emission principle in which an electron is emitted when an electric field is applied to a pointy conductive emitter in a vacuum state.

FIG. 1 is a schematic cross-sectional view of an FED using a conventional CNT emitter. An operation principle of the FED using CNT will now be described with reference to FIG. 1.

Referring to FIG. 1, the FED 100 includes an electron emission part 110 in which an emitter 114 is formed as an electron emitter, and an image display part 130 which has a fluorescent layer 135 generating light by colliding the light emitted from the electron emission part 110 with a fluorescent material.

The image display part 130 includes a second substrate 131, an anode 133 formed on the second substrate 131, fluorescent layers 135 formed on the anode 133 to be spaced apart from each other, and a light shielding layer 137 formed between the fluorescent layers 135. The light shielding layer 137 serves as a boundary between pixels.

The electron emission part 110 includes a first substrate 111, cathodes 113 formed on the first substrate 111 to be spaced apart from each other in a predetermined shape, a CNT emitter 114 manufactured using CNT on the cathode 113, and a gate electrode 119 insulated from and adjacent to the cathode 113. An insulating layer 118 is formed under the gate electrode 119. A spacer 140 is disposed between the electron emission part 110 and the image display part 130 to support them.

To manufacture the CNT emitter 114, CNT paste first has to be manufactured. The CNT paste may be manufactured by the steps of: (1) dispersing CNT and a metal filler; (2) adding an organic binder and a photosensitive resin; and (3) mixing the added materials using a solvent and adjusting its viscosity. The CNT paste manufactured by steps (1) to (3) is applied onto the cathode 113 of the electron emission part 110, and then exposed and patterned, and thus the CNT emitter 114 may be completed.

However, when the CNT emitter 114 is manufactured using the above-described CNT paste, there is a limitation to performance of the FED because adhesion between the cathode 113 and the CNT emitter 114 is not uniform, and thus resistance between the cathode 113 and the CNT emitter 114 or between CNTs of the CNT emitter 114 becomes high or non-uniform. That is, since the CNT emitter 114 is not formed on the cathode 113 with strong adhesion, when a strong electric field is generated in the CNT emitter 114, the CNT emitter 114 may be detached from the cathode 113. For this reason, contact resistance between the CNT emitter 114 and the cathode 113 may be non-uniform or increased, and only some of the CNT emitters 114 contribute to electron emission, thereby deteriorating an electron emission characteristic, which results in a decrease in electron emission sites and non-uniform distribution of electron emission. Also, since the resistance between the CNTs of the CNT emitter 114 may not be uniform, only some of the CNT emitters 114 serve to emit electrons, and thus a lifespan of the CNT emitter 114 drastically decreases.

To overcome the above-described problems, a method of reinforcing a role of the metal filler added to CNT paste is recently disclosed. FIG. 2 is a partial cross-sectional view of an enlarged region II of the CNT emitter 114 of FIG. 1, in which the role of the metal filler 115 added to the CNT paste is reinforced.

Since the submicrometer-sized metal filler 115 illustrated in FIG. 2 is significantly larger than the CNT 117, a dispersion degree in the CNT paste is not only very weak, but agglomeration A of the metal filler 115 and the CNT 117 may also occur. To reduce the agglomeration A, the metal filler 115 is made as small as possible, and thereby the non-uniform degree of dispersion between the metal filler 115 and the CNT 117 may be partially overcome.

However, the problems of the adhesion between the cathode 113 and the CNT emitter 114, and the resistance non-uniformity between the cathode 113 and the CNT emitter 114 or between the CNTs of the CNT emitter 114 may not be thoroughly resolved only by reducing the size of the metal filler 115.

### DISCLOSURE OF INVENTION

### Technical Problem

The present invention is directed to a method of manufacturing carbon nanotube (CNT) paste improving adhesion between a CNT emitter and a cathode by adding a nano-sized metal particle which is soluble at a low temperature at which CNTs do not deteriorate.

Also, the present invention is directed to a method of manufacturing a CNT emitter with high reliability, which can improve uniformity of electron emission and increase electron emission sites by using CNT paste having a nano-sized metal particle.

### Technical Solution

One aspect of the present invention provides a method of manufacturing carbon nanotube (CNT) paste, comprising the steps of: (i) dispersing CNT powder in a solvent; (ii) adding an organic binder to the solution in which the CNT powder is dispersed; and (iii) performing a milling process to adjust viscosity of the dispersion solution to which the organic binder is added, wherein a nano-sized metal particle is added in step (i) or (iii).

The present invention may further comprise the step of adding a photosensitive material and a monomer which is polymerized with the organic binder by reacting with the photosensitive material in the mixed dispersion solution.

When the metal particle is formed in a powder type, the metal particle may be added in step (i), whereas, when the metal particle is formed in a paste type, the metal particle may be added in step (iii). The metal particle is melted at a lower temperature than a deterioration point of the CNT powder. The metal particle may comprise Ag, Ru, Ti, Pd, Zn, Fe, or Au, which has excellent conductivity. The deterioration temperature of the CNT powder may be between 400 and 550° C.

The CNT powder and the metal particles may constitute the CNT paste with a weight percentage of 1:2. The solvent may have a good surface active characteristic, and be formed of isopropyl alcohol (IPA) and terpineol.

Another aspect of the present invention provides a method of manufacturing a CNT emitter, comprising the steps of: preparing the CNT paste manufactured by the manufacturing method of the CNT paste according to any one of claims 1 through 9; applying the CNT paste onto an electrode formed over a substrate; exposing and patterning the CNT paste applied onto the electrode; plasticizing the patterned CNT paste; and treating a surface of the plasticized CNT paste to be activated.

The step of plasticizing the CNT paste may comprise at least one of the steps of: plasticizing the CNT paste at about 250 to 300° C. in an atmosphere; and plasticizing the CNT paste at about 320 to 450° C. in a vacuum.

In the step of plasticizing the CNT paste in an atmosphere, burning-out of the organic binder and melting of the metal particle may be performed. In the step of plasticizing the CNT paste in a vacuum, carbonization of the remaining organic binder and additional melting of the metal particle may be performed.

In the step of treating the surface of the CNT paste, a rolling treatment in which glue does not get leftover may be performed.

### Advantageous Effects

As described above, a nano-sized metal particle capable of being melted at a low temperature at which carbon nanotubes (CNTs) do not deteriorate may be added, thereby improving adhesion between a CNT emitter and a cathode. Also, CNT paste is evenly mixed in a conductor with excellent conductivity due to the melted metal particle, and thus the CNT emitter and the metal particle are stably adhered to a field emission device (FED), which induces uniform electron emission.

The adhesion between the CNT emitter and the cathode is improved by the melted metal particle, thereby reducing resistance between the cathode and the CNT, or between the CNTs. In result, the electron emission may be constantly maintained, and the density of an active emission site contributing to the electron emission may be increased, and thus the CNT emitter with high reliability may be provided.

### BRIEF DESCRIPTION OF THE DRAWINGS

FIG. 1 is a schematic cross-sectional view of a field emission device (FED) using a conventional carbon nanotube (CNT) emitter;

FIG. 2 is a partial cross-sectional view of an enlarged region II of the CNT emitter of FIG. 1;

FIG. 3 is a block diagram illustrating a method of manufacturing CNT paste according to the present invention;

FIG. 4 is a block diagram illustrating a method of manufacturing a CNT emitter using the CNT paste manufactured in FIG. 3;

FIG. 5A is an enlarged cross-sectional view schematically illustrating a CNT emitter patterned using CNT paste to which a nano-sized metal particle is added according to an exemplary embodiment of the present invention;

FIG. 5B is an enlarged cross-sectional view schematically illustrating a completed CNT emitter after the step of plasticizing the CNT emitter in FIG. 3; and

FIGS. 6A to 6B are graphs respectively illustrating electron emission characteristics and electron emission uniformity versus time between the CNT emitter manufactured according to the present invention and the CNT emitter manufactured according to the conventional art.

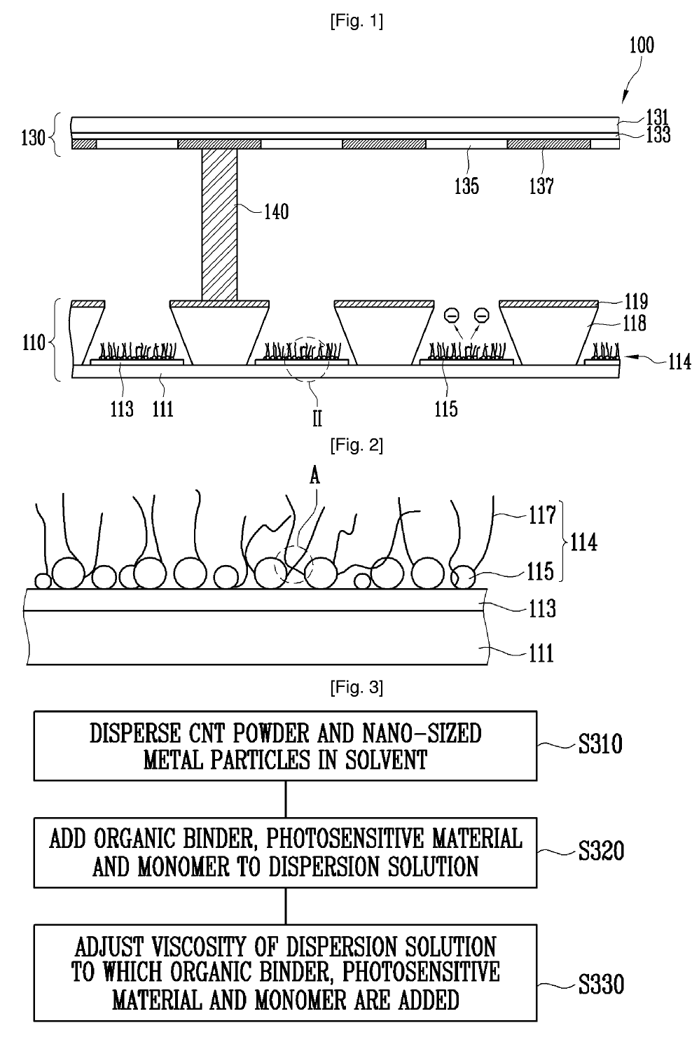

### DESCRIPTION OF MAJOR SYMBOL IN THE ABOVE FIGURES

500: CNT emitter
510: Substrate
520: Electrode
530: CNT paste
531: CNT (powder)
532 and 532a: Metal particles

### MODE FOR THE INVENTION

Hereinafter, exemplary embodiments of the present invention will be described in detail. However, the present invention is not limited to the embodiments disclosed below, but can be implemented in various forms. Therefore, the following embodiments are described in order for this disclosure to be complete and enabling to those of ordinary skill in the art.

FIG. 3 is a block diagram illustrating a method of manufacturing carbon nanotube (CNT) paste according to the present invention. Referring to FIG. 3, to manufacture CNT paste, CNT powder and nano-sized metal particles are first dispersed in a solvent (S310).

Here, the metal particle may have a size of several or several tens of nanometers, and be formed in a powder or paste type. When the CNT powder and the nano-sized metal particles are dispersed together, the powdery metal particles are used. Although the step of dispersing the powdery metal particles together with the CNT powder is disclosed herein, the CNT paste may be manufactured using paste-type metal particles. In this case, the paste-type metal particles are added in a milling step that is a subsequent process.

The metal particle may be a highly conductive metal capable of making an ohmic contact to lower interface resistances between the CNTs, and between the CNT and a cathode (not illustrated) of the CNT emitter formed using the CNT paste. The highly conductive metals usable for the CNT paste include Ag, Ti, Pd, Zn, Au, Fe and Ru, which are individually used or properly mixed for use. Since the nano-sized metal particle is formed by mixing various metals, its adhesion and electrical characteristics may be improved.

The CNT powder and the nano-sized metal particles can be dispersed in most solvents such as a water-soluble solvent, an organic solvent, etc. However, in general, after dispersion is completed and then a predetermined time elapses, since the nano materials such as CNTs tend to agglomerate with each other, the solvent preferably has a good surface active characteristic. It is preferable that an additional solvent having a high temperature for vaporization (boiling point: about 150° C. or more) is used together to protect rapid evaporation.

In this embodiment, the CNT powder and the nano-sized metal particles are dispersed in isopropyl alcohol (IPA) and terpineol which have a good surface active characteristic. In a case of using a mixed solvent of IPA and terpineol as a dispersing solvent, only terpineol is left after the CNT paste is completed. This is because the IPA, being used to disperse the CNTs, is dried after the CNT dispersion. The boiling point of the terpineol left after the CNT paste is manufactured is in a range of about 120 to 170° C.

Also, in the manufacturing the CNT paste, the CNT powder and the nano-sized metal particles are included with an appropriate composition ratio in consideration of a configuration of the CNT emitter to be manufactured employing the same. Here, in terms of a weight percentage (wt %), a composition ratio of the CNT powder to the metal particle is 1:2.

In the next step, an organic binder, a photosensitive material and a monomer are added to the dispersion solution in which the CNT powder and the nano-sized metal particles are dispersed (S320). As the organic binder added to the dispersion solution, various kinds of polymers such as acryl resin series or ethyl cellulose may be commonly used. The photosensitive material (photo initiator) directs the monomer to react when receiving light, which may be selected depending on the kind of the added organic binder, and particularly, a material matched with the organic binder may be preferably selected.

The monomer is a material added to obtain a patterning characteristic by exposure, which serves to be polymerized with a polymer by being initiated by the photosensitive material. The photosensitive material has to be optimized with an appropriate weight ratio of the monomer to the organic binder, and if the ratio is not appropriate, it may affect the final configuration of the CNT emitter. Thus, the photosensitive material is added to have a weight ratio ranging from 1/10 to 1/100 of the organic binder, and the monomer is added to have the same ratio as the photosensitive material. As such, when the photosensitive material is mixed in the CNT paste, the CNT paste applied on the substrate or electrode may be formed in a specific shape by exposure.

Although the method of manufacturing the CNT paste by adding the photo sensitive material is disclosed herein, the CNT paste may be patterned by a screen printing method when the photosensitive material is not added. In this case, the patterning is more effective to form a large pattern of 100 μm or more.

In the next step, the viscosity of the dispersion solution, to which the organic binder, the photoresist material, and the monomer are added, is adjusted (S330). A milling process is used to adjust the viscosity of the dispersion solution. A method of manufacturing a CNT emitter using the CNT paste manufactured through steps S310 to S330 will be described below.

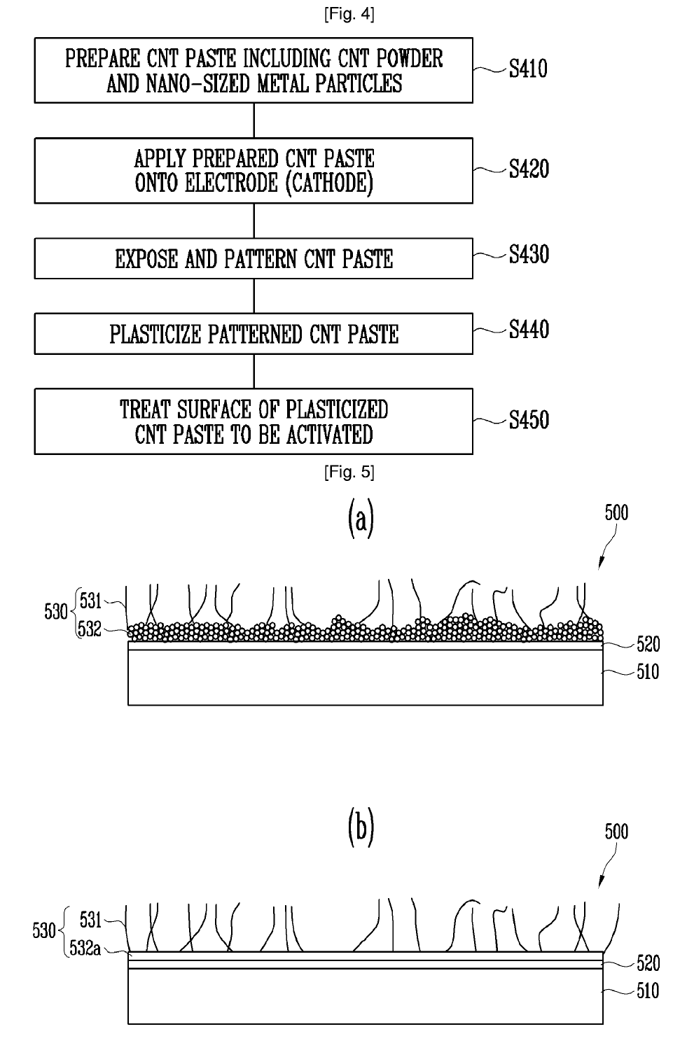

FIG. 4 is a block diagram illustrating a method of manufacturing a CNT emitter using the CNT paste manufactured in FIG. 3; FIG. 5A is an enlarged cross-sectional view schematically illustrating a CNT emitter patterned with a CNT paste to which a nano-sized metal particle is added according to an exemplary embodiment of the present invention; and FIG. 5B is an enlarged cross-sectional view schematically illustrating a CNT emitter completed after the step of plasticizing the CNT emitter of FIG. 3.

Referring to FIGS. 4 and 5A, to manufacture a CNT emitter 500, CNT paste 530 including CNT powder 531 and nano-sized metal particles 532 is first prepared (S410). The process of manufacturing the CNT paste 530 refers to the steps of FIG. 3 (from S310 to S330). Following the preparation of the CNT paste 530, the CNT paste 530 is applied onto an electrode 520 (a cathode) formed on a substrate 510 of a field emission device (FED) (S420). In the next step, the CNT paste 530 applied onto the cathode 520 is exposed and patterned in a desired pattern (S430).

Referring to FIGS. 4 and 5B, after patterning the CNT paste 530, the patterned CNT paste 530 is plasticized (S440). The step of plasticizing the CNT paste 530 (S440) includes a first plasticizing process performed at about 250 to 300° C. in the atmosphere, and a second plasticizing process performed at about 320 to 450° C. in a vacuum. In the first plasticizing process, an organic binder included in the CNT paste 530 can be burned out, and the metal particles can be melted depending on the kind of the metal particle. In the second plasticizing process, the metal particles may be melted under the above-mentioned conditions (in a vacuum and at a temperature of 320 to 450° C.). Generally, the melting point of metal depends on the relative ratio between a surface area of the metal particle and a weight of the metal particle. Metal commonly having a melting point of 800° C. can be melted at about 400° C., which is half the melting point, if the metal particle becomes smaller than μm or less, whereas it can be melted at about 100° C., if the metal particle is split into several to several tens nm size. These characteristics may depend on the kind of metal and the surrounding of a melting particle.

Through the plasticizing step (S440), the burning-out of the organic binder and the melting of the metal particles are completed, and thus the CNT emitter 500 is strongly adhered onto the cathode 520 as illustrated in FIG. 5B. In the next step, a surface of the plasticized CNT paste 500 is surface-treated to be activated (S450). For the surface treatment, various methods may be used, such as a plasma treatment, a high field treatment, a taping treatment and a rolling treatment. The rolling treatment is preferable because it removes an out-gassing problem in a vacuum and glue does not get leftover.

In the CNT emitter 500 manufactured through the above-described steps, unlike the conventional CNT emitter illustrated in FIG. 2, nano-sized metal particles 532a and nano-sized CNTs 531 are evenly dispersed. Also, a contact between the CNTs may be uniformly made by the melted metal and the FED, which includes the CNT emitter 500 having an improved electron emission characteristic through the physical surface treatment steps, can be finally manufactured. Particularly, when the CNT emitter 500 is manufactured through the manufacturing process, the emitter may have an ideal configuration so that its adhesion is far more improved than when it is simply adhered with a metal filler, thereby reducing electrical resistance and improving uniformity thereof.

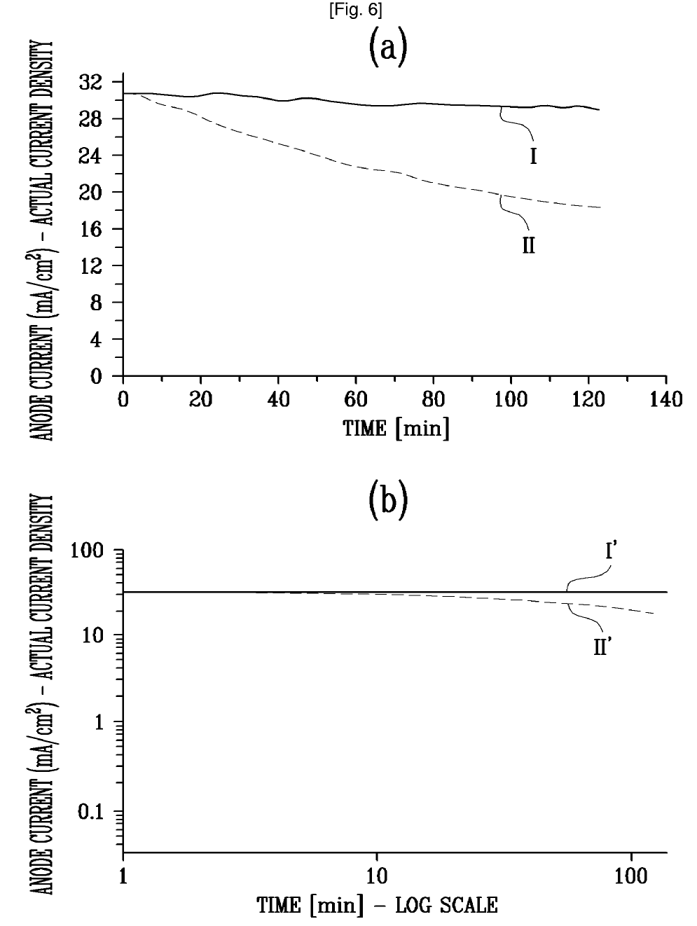

FIGS. 6A and 6B are graphs respectively illustrating electron emission characteristics and uniformity of current density versus time between the CNT emitter manufactured according to the present invention and the CNT manufactured according to the conventional art.

FIG. 6A is a graph illustrating an electron emission characteristic, in which an x axis represents time, a y axis represents current density, and continuous electron emission is performed at a DC voltage. Graph (I) shows an electron emission characteristic of the CNT emitter manufactured using CNT paste according to the present invention, and graph (II) shows an electron emission characteristic of the CNT emitter manufactured using CNT paste according to conventional art. Referring to graphs (I ) and (II), initial current densities in the both graphs are about 30 mA/cm². In the beginning of measuring the current density, the CNT emitter according to the present invention and the CNT emitter according to the conventional art have almost the same current density. However, it can be identified that the CNT emitter according to the present invention has a current density of about 30 mA/cm², and the conventional CNT emitter has a current density of about 19 mA/cm² after two hours. That is, it can be noted that the CNT emitter manufactured according to the present invention uniformly emits electrons as compared with the conventional CNT emitter in an environment of continuous electron emission for about two hours.

FIG. 6B is a graph illustrating uniformity of current density, in which an x axis represents time (log scale), and a y axis represents current density. Graph (I′) shows uniformity of current density of the CNT emitter manufactured using the CNT paste according to the present invention, and graph (II′) shows uniformity of current density of the CNT paste according to the conventional art. It can be noted that the current density according to graph (I′) is almost constant, but the current density according to graph (II′) is reduced as the time goes on.

Consequently, when the CNT emitter is manufactured using the CNT paste formed according to the present invention, the current density is merely changed after a pre-determined time (in graphs I and I′), but when the CNT emitter is manufactured using the CNT paste according to the conventional art (in graphs II and II′), the current density is significantly reduced. Thus, it can be noted that the adhesion of the CNT emitter is drastically improved due to the melted nano-sized metal particles employed in the CNT paste, thereby significantly improving the electron emission characteristic and reliability including uniformity.

While the invention has been shown and described with reference to certain exemplary embodiments thereof, it will be understood by those skilled in the art that various changes in form and details may be made therein without departing from the spirit and scope of the invention as defined by the appended claims.

1. A method of manufacturing carbon nanotube (CNT) paste, comprising the steps of:
(i) dispersing CNT powder in a solvent;
(ii) adding an organic binder to the solution in which the CNT powder is dispersed; and
(iii) performing a milling process to adjust viscosity of the dispersion solution to which the organic binder is added,
wherein a nano-sized metal particle is added in step (i) or (iii).

2. The method according to claim 1, further comprising the step of (iv) adding a photosensitive material and a monomer which is polymerized with the organic binder by reacting with the photosensitive material, in the mixed dispersion solution.

3. The method according to claim 1, wherein, when the metal particle is formed in a powder type, the metal particle is added in step (i).

4. The method according to claim 1, wherein, when the metal particle is formed in a paste type, the metal particle is added in step (iii).

5. The method according to claim 1, wherein the metal particle is melted at a lower temperature than a melting point of the CNT powder.

6. The method according to claim 5, wherein the metal particle comprises Ag, Ru, Ti, Pd, Zn, Fe, or Au, which has excellent conductivity.

7. The method according to claim 1, wherein the CNT powder and the metal particles constitute the CNT paste with a weight percentage of 1:2.

8. The method according to claim 1, wherein the solvent has a good surface active characteristic.

9. The method according to claim 8, wherein the solvent comprises isopropyl alcohol (IPA) and terpineol.

10. A method of manufacturing a CNT emitter, comprising the steps of:
preparing the CNT paste manufactured by the manufacturing method of the CNT paste according to claim 1;
applying the CNT paste onto an electrode formed over a substrate;
exposing and patterning the CNT paste applied onto the electrode;
plasticizing the patterned CNT paste; and
treating a surface of the plasticized CNT paste to be activated.

11. The method according to claim 10, wherein the step of plasticizing the CNT paste comprises at least one of the steps of:
plasticizing the CNT paste at about 250 to 300° C. in an atmosphere; and
plasticizing the CNT paste at about 320 to 450° C. in a vacuum.

12. The method according to claim 11, wherein, in the step of plasticizing the CNT paste in an atmosphere, burning-out of the organic binder and melting of the metal particle are performed.

13. The method according to claim 12, wherein, in the step of plasticizing the CNT paste in a vacuum, carbonization of the remaining organic binder and additional melting of the metal particle are performed.

14. The method according to claim 10, wherein, in the step of treating the surface of the CNT paste, a rolling treatment, in which glue does not get leftover, is performed.
